(19) United States
(12) Patent Application Publication
(10) Pub. No.: US 2013/0063948 A1
(43) Pub. Date: Mar. 14, 2013

(54) LUMINAIRE

(71) Applicant: Yasuhiko ISHII, Kanagawa-ken (JP)

(72) Inventor: Yasuhiko ISHII, Kanagawa-ken (JP)

(73) Assignee: TOSHIBA LIGHTING & TECHNOLOGY CORPORATION, Yokosuka-shi (JP)

(21) Appl. No.: 13/608,109

(22) Filed: Sep. 10, 2012

(30) Foreign Application Priority Data
Sep. 14, 2011 (JP) 2011-200379

(51) Int. Cl. F21V 3/02; F21V 7/00; F21V 29/00

(52) U.S. Cl. 362/294; 362/311.1; 362/296.01

(57) ABSTRACT

A luminaire of an embodiment includes an apparatus body, a light source unit, and a cover member. The light source unit is disposed in the apparatus body and including a light-emitting element as a light source. The cover member has translucency and diffusing properties, is formed so as to project from a front side edge portion of the apparatus body, includes a side wall extending along the edge portion and formed upright within a range of inner angle from 60° to 90° with reference to a horizontal plane at least partly along the edge portion, and covers the light source unit so as to leave a substantially center portion of the apparatus body as an uncovered portion.

### CROSS-REFERENCE TO RELATED APPLICATIONS

This application is based upon and claims the benefit of priority from Japanese Patent Application No. 2011-200379, filed on Sep. 14, 2011; the entire contents of which are incorporated herein by reference.

### FIELD

Embodiments described herein relate generally to a luminaire.

### BACKGROUND

Recently, in association with high power and high efficiency of LEDs, luminaires employing LEDs as light sources and configured to be used indoors and outdoors, which promise longer life are developed. Such luminaires are configured to include a plurality of LEDs mounted on a substrate to achieve a predetermine brightness, and are used as base lights to be mounted on system ceilings of offices.

With such luminaires, light in a predetermined light distribution range is radiated downward from the side of a ceiling surface to illuminate room interiors.

However, in the luminaires as described above, since directional characteristics of light emitted from the LEDs as light sources are strong, the light distribution range may easily be narrowed. Therefore, improvement of a feeling of brightness in the entire room interior may become difficult.

### BRIEF DESCRIPTION OF THE DRAWINGS

FIG. 1 is a perspective view illustrating a luminaire according to an embodiment;

FIG. 2 is a perspective view of the luminaire viewed from the front side illustrating a state in which an equipment plate is removed;

FIG. 3 is an exploded perspective view showing the luminaire;

FIG. 4 is a cross-sectional view taken along the line X-X in FIG. 1;

FIG. 5 is an enlarged cross-sectional view illustrating a portion A in FIG. 4;

FIG. 6 is a perspective view illustrating a module of a light source unit in the luminaire; and

FIG. 7 is a perspective view illustrating a state of mounting a supporting fixture in the luminaire.

### DETAILED DESCRIPTION

A luminaire according to an embodiment includes an apparatus body, and a light source unit disposed in the apparatus body and including light-emitting elements as light sources.

The luminaire also includes cover members having translucency and diffusing properties. The cover members are formed so as to project from front side edge portions of the apparatus body, include side walls extending along the edge portions and formed upright within a range of 60° to 90° in inner angle with reference to a horizontal plane at least partly along the edge portions, and configured to cover the light source units so as to leave a substantially center portion of the apparatus body as an uncovered portion.

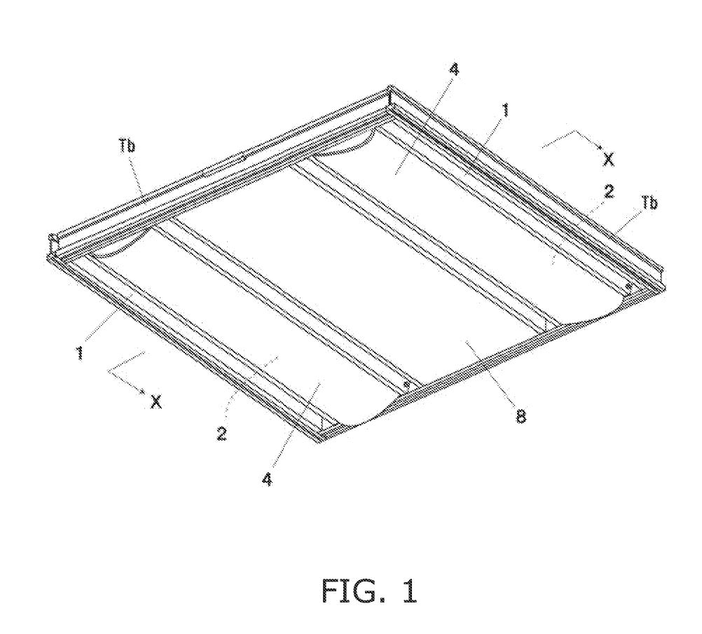

Referring now to FIG. 1 to FIG. 7, the luminaire according to an embodiment will be described. In respective drawings, illustration of interconnection members such as lead wires are omitted, the same parts are designated by the same reference numerals and overlapped descriptions are omitted.

In FIG. 1 to FIG. 3, a base light to be installed as a luminaire on a system ceiling composed of T bars assembled to a ceiling of the office or the like in a lattice pattern is illustrated, and the luminaire is formed in substantially a square shape.

As illustrated in FIG. 1, the luminaire is assembled in T bars (Tb) installed on the ceiling in a lattice pattern. In FIG. 1, T bars (Tb) are illustrated partly. The luminaire includes an apparatus body 1, light source units 2 disposed in the apparatus body 1, thermal radiation members 3, translucent cover members 4 covering the light source units 2, supporting fixtures 5 configured to support the light source units 2, and fixing devices 6 configured to fix the supporting fixtures 5. The apparatus body 1 includes also lighting devices 7 configured to perform the lighting control of the light source units 2 and an equipment plate 8. The luminaire as described above has a light radiating surface on the front side and a mounting surface with respect to the ceiling side on the back side.

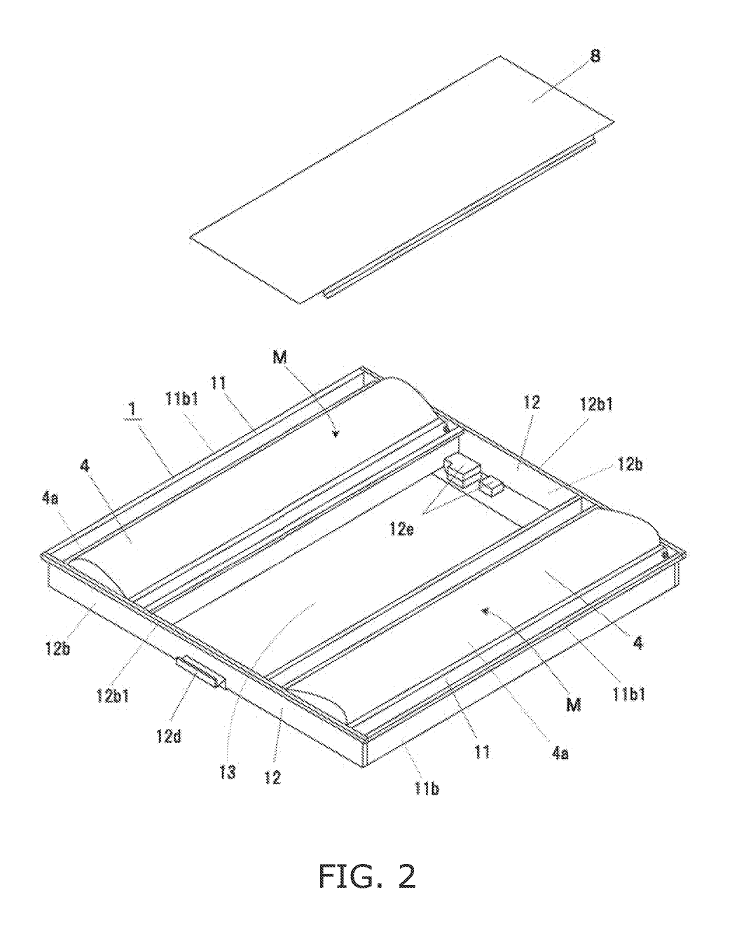

As illustrated in FIG. 2 to FIG. 5, the apparatus body 1 is a substantially square-shaped chassis, and includes light source unit supporting members 11 and end plate members 12. The light source unit supporting members 11 and the end plate members 12 are formed by painting metallic plates having thermal conductivity such as hot dip galvanizing steel plates or the like white in order to enhance reflectance.

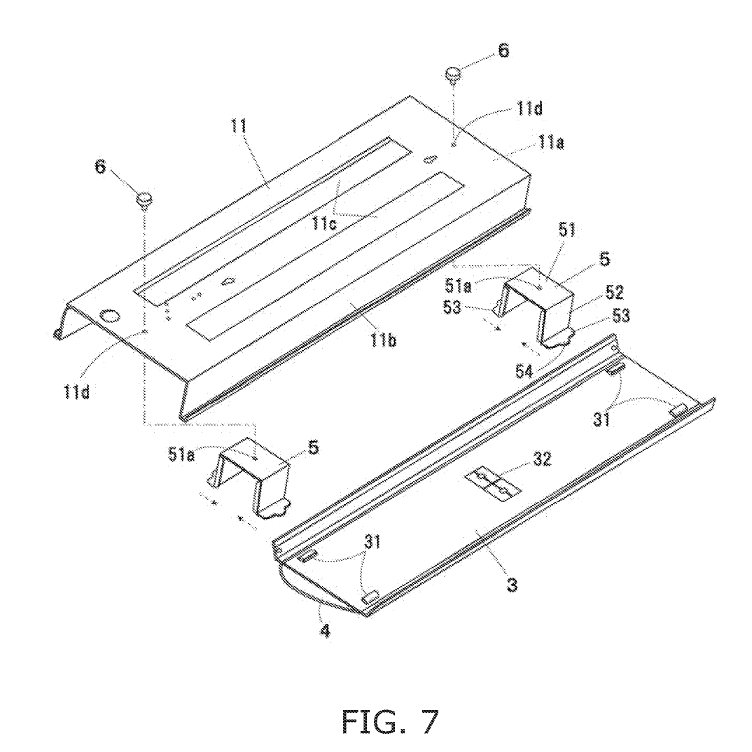

In the embodiment, the light source units 2 for two-lamp type are disposed in two lines at two positions in parallel and, accordingly, the light source unit supporting members 11 are are arranged in two rows. The light source unit supporting members 11 are each have a substantially U-shape in side view, and includes a back wall 11a and side walls lib bent toward the front side from both sides along the longitudinal direction of the back wall 11a as also illustrated in FIG. 7.

The back wall 11a is formed with a pair of laterally elongated rectangular openings 11c, and mounting screw through holes 11d at both end portions in the longitudinal direction. Edge portions extending along the longitudinal directions in the side walls 11b are bent into a flange shape.

A pair of the end plate members 12 are each formed into an elongated substantially L-shape and includes a back wall 12a and a side wall 12b. The back wall 12a is formed with mounting screw through holes 12c, and a fixture 12d to be supported by the T bar (Tb) installed on the ceiling and bent into a key shape is attached to the outside of the side wall 12b. The back wall 12a of one of the end plate members 12 is provided with terminal bases 12e for connecting a power cable and a dimming signal line attached thereto.

A pair of such end plate members 12 are provided so as to close openings at both end portions of the light source unit supporting members 11 in the longitudinal direction. Therefore, the apparatus body 1 is configured by combining the light source unit supporting members 11 and the end plate members 12 to form a substantially square shape, and the side walls 11b of the light source unit supporting members 11 and the side wall 12b of the end plate members 12 form the outer shape of the apparatus body 1.

Furthermore, as mainly illustrated in FIG. 2, front side edge portions 11b1 of one of the side walls 11b (the side walls positioned on the outsides) of the respective light source unit supporting members 11 arranged in two rows and front side edge portions 12b1 of the side walls 12b of a pair of the end plate members 12 form the outer shape of the front side of the apparatus body 1.

The apparatus body 1 may be a chassis in the embodiment. However, the apparatus body 1 may be those referred to as a case, a reflection board, or a base, and is not constrained by the appellation of the member. For example, the apparatus body 1 may be a member formed into a box shape opening on the front side into a square shape. In general, the apparatus body 1 means a member or a portion on which the light source units 2 are directly or indirectly disposed, and is not understood in a limited way.

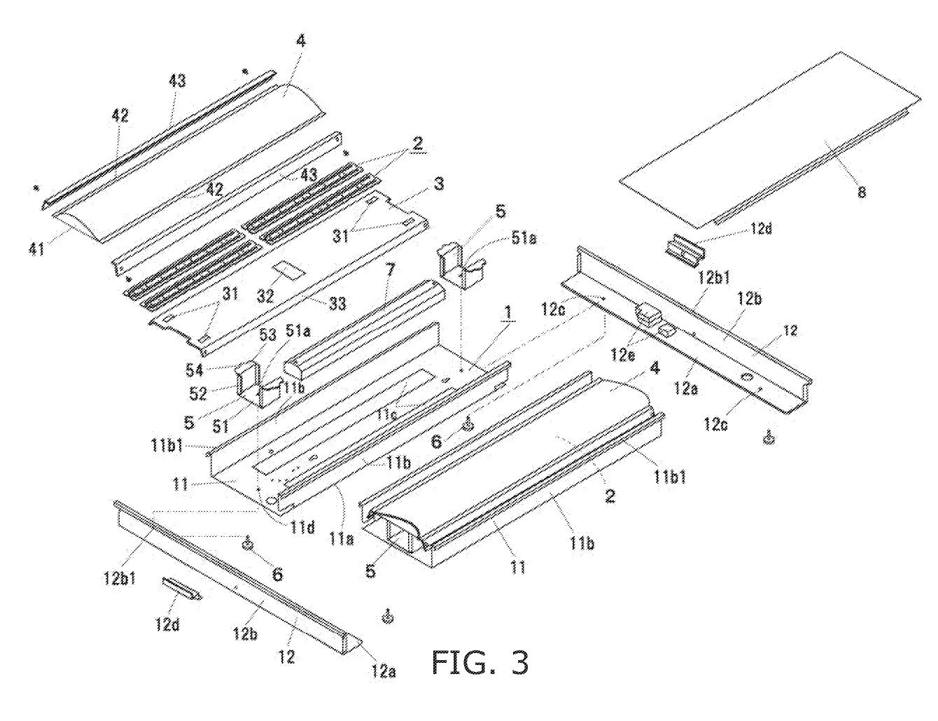

The light source units 2 include a substrate 21, a plurality of light-emitting elements 22 mounted on the substrate 21, and phosphor layers 23 configured to cover the respective light-emitting elements 22 as illustrated in FIG. 3 to FIG. 6 as representatives. Although FIG. 3 illustrates an exploded perspective view of the luminaire, only one (left side in the illustration) of the light source units 2 is exploded for the sake of convenience of description.

The substrate 21 is formed of an insulating material such as glass epoxy resin (FR-4) or the like into an elongated rectangular shape. A interconnection pattern layer formed of copper foil is formed on the front side. On the interconnection pattern layer, resist layer 21a is formed as needed. A plurality of the substrates 21, more specifically, four of the substrates 21 are arranged in two rows on the thermal radiation member 3 described later.

Examples of the material of the substrates 21 include ceramics materials, synthetic resin materials, or metal-based substrates formed by superposing an insulating layer over the surface of a base plate having high thermal conductivity and superior in thermal radiation properties such as aluminum for the purpose of enhancing thermal radiation properties of the light-emitting element 22, and the material is not specifically limited.

The substrates 21 is superposed with the white resist layer 21a having a high reflectance over the entire front surface except for areas where the light-emitting elements 22 are mounted or portions where components are mounted. Light proceeding sideway out of light emitted from the light-emitting elements 22 is reflected by the surface of the white resist layer 21a having a high reflectance and radiated toward the front.

The plurality of light-emitting elements 22 are composed of LED bear chips. The LED bear chips include a substance which emits blue light in order to cause a light-emitting portion to emit white based light. The LED bear chips are bonded on the interconnection pattern layer using a silicone resin-based insulative adhesive agent and are electrically connected to the interconnection pattern layer by bonding wires.

The phosphor layers 23 are formed of a translucent synthetic resin, for example, a transparent silicone resin, and contains phosphor such as YAG:Ce or the like by a suitable amount. The phosphor layers 23 are formed into a low, and substantially cylindrical shape so as to cover the individual light-emitting elements 22 from one element to another. The phosphor is excited by light emitted by the light-emitting elements 22 and radiates light in a color different from the color to light emitted by the light-emitting elements 22. In the embodiment in which the light-emitting elements 22 emit blue light, yellow phosphor which radiates yellowish light which is in a compensating relationship with the blue light is used in order to allow emission of white light.

The shape of the phosphor layers 23 is not specifically limited as long as the individual light-emitting elements 22 are covered, and an swelled shape, or a line shape which covers continuously the plurality of light-emitting elements 22 may be applied. As the light-emitting elements, a surface-mounted LED package may be used, and a method or a form of mounting is not specifically limited.

The thermal radiation members 3 are formed into a substantially rectangular shape, and are formed by painting metallic plates having thermal conductivity such as hot dip galvanizing steel plates or the like white. Formed on both end portion sides of the thermal radiation members 3 are one pair each of insertion holes 31 formed by being deformed so as to bulge slightly toward the back side by incision. Formed at a substantially center portion of the thermal radiation member 3 is a interconnection insertion hole 32 which allows insertion of interconnection such as lead wires or the like connected to the substrate 21. In addition, mounting strips 33 extending toward the back side are formed on both sides along the longitudinal direction of the thermal radiation member 3.

The back side of the substrate 21 is disposed in surface contact with the thermal radiation member 3.

As illustrated in FIGS. 1 to 6, the cover members 4 are each formed of an insulative material such as acrylic resin or polycarbonate resin mixed with diffusing agent to be taken on milky-white color to provide light diffusing properties and translucency.

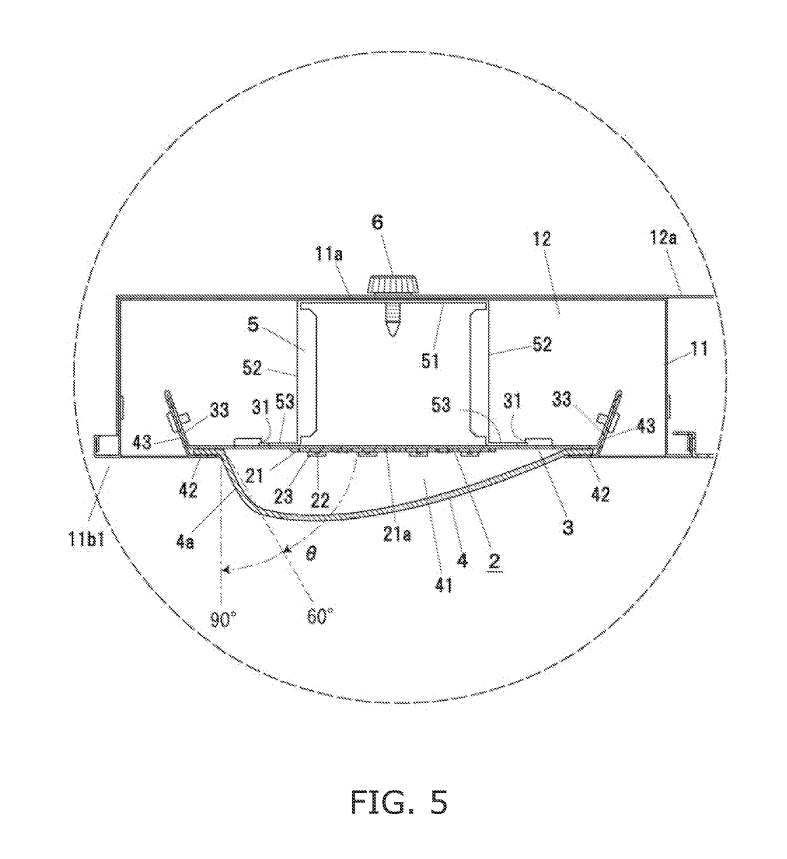

The cover members 4 are each formed into a protruding shape with a top portion deviated to one side in side view, and, as illustrated in FIG. 5, include one side wall 4a formed so as to extend upright rising steeply within a range of inner angle θ from 60° to 90° with reference to a horizontal plane. Formed also on both end portions of the cover member 4 in the longitudinal direction integrally are end plates 41. Furthermore, flat mounting strips 42 are formed on both sides along the longitudinal direction of the cover member 4. In this manner, the cover members 4 are formed to have a curved shape having an outer inclination larger than an inner inclination so as to face the light-emitting elements 22.

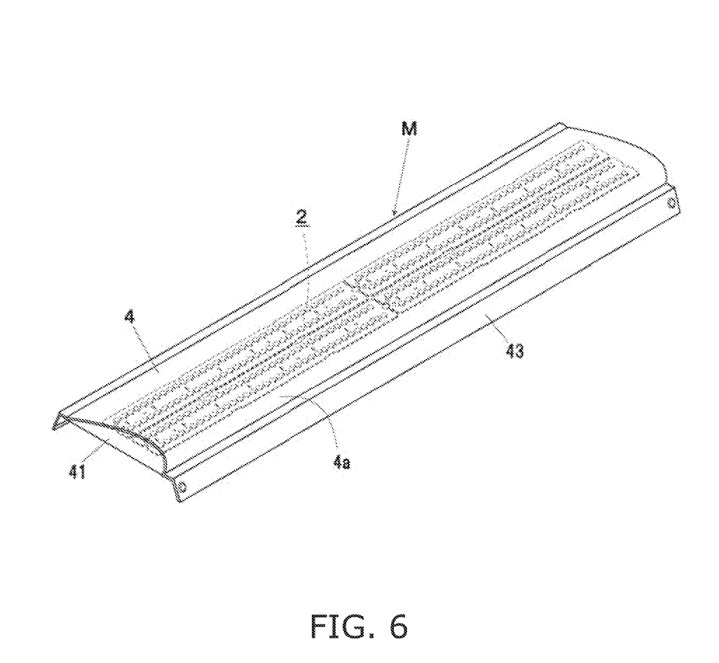

As illustrated in FIG. 3 to FIG. 6, the light source unit 2, the thermal radiation member 3, and the cover member 4 described above are combined and constitute one module M (see FIG. 6). More specifically, the back side of the substrate 21 is mounted in surface contact with the flat surface of the thermal radiation members 3 on the front side. Accordingly, the substrate 21 is thermally coupled to the thermal radiation members 3. Then, the cover member 4 is arranged on the thermal radiation member 3 so as to cover the light source units 2, and the cover member 4 is assembled to the thermal radiation member 3 with cover supporting fixtures 43.

More specifically, the cover supporting fixtures 43 are bent and formed along the longitudinal direction, and are fixed to the mounting strips 33 of the thermal radiation members 3 with rivet as illustrated in FIG. 5 as a representative. By such fixation, the cover supporting fixtures 43 hold the flat mounting strips 42 of the cover members 4 tightly with the thermal radiation members 3.

As illustrated in FIG. 3 to FIG. 5, a pair of the supporting fixtures 5 are provided and are formed by bending a metallic plate into a substantially angular U-shape, and each includes a rectangular-shaped fixing portion 51 and extending portions 52 extending upright from both sides of the fixing portion 51. The fixing portions 51 are each formed with a screw hole 51a at substantially centers thereof, and mounting tongue strips 53 at distal end portions of the extending portions 52. The mounting tongue strips 53 are each formed with an insertion portion 54 to be inserted into the insertion hole 31 formed the thermal radiation member 3.

Subsequently, referring mainly to FIG. 5 and FIG. 7, a state of mounting of the supporting fixtures 5 that supports the light source unit 2, that is, the module M will be described. The supporting fixtures 5 are configured to be reduced in widthwise dimension by resiliently deforming the mounting tongue strips 53 side at the distal end portions of the extending portions 52 in the width direction.

Therefore, the mounting tongue strips 53 sides are resiliently deformed so as to be reduced in widthwise dimension and the insertion portions 54 of the mounting tongue strips 53 are aligned with positions of the insertion holes 31 of the thermal radiation member 3 on the back side thereof, and the resilient deformation is released to restore the original state. Accordingly, the mounting tongue strips 53 are inserted into the insertion holes 31, and the supporting fixtures 5 are attached to the thermal radiation members 3.

In this state, the supporting fixtures 5 are fixed to the light source unit supporting members 11 by the fixing devices 6 from the back side of the apparatus body 1, that is, from the back side of the light source unit supporting members 11. The fixing devices 6 are attachment screws, and the attachment screws are inserted through the mounting screw through holes 11d of the light source unit supporting members 11 via the mounting screw through holes 12c of the end plate members 12, and then screwed into the screw holes 51a formed on the supporting fixtures 5. In this manner, the light source units 2 are mounted on the apparatus body 1.

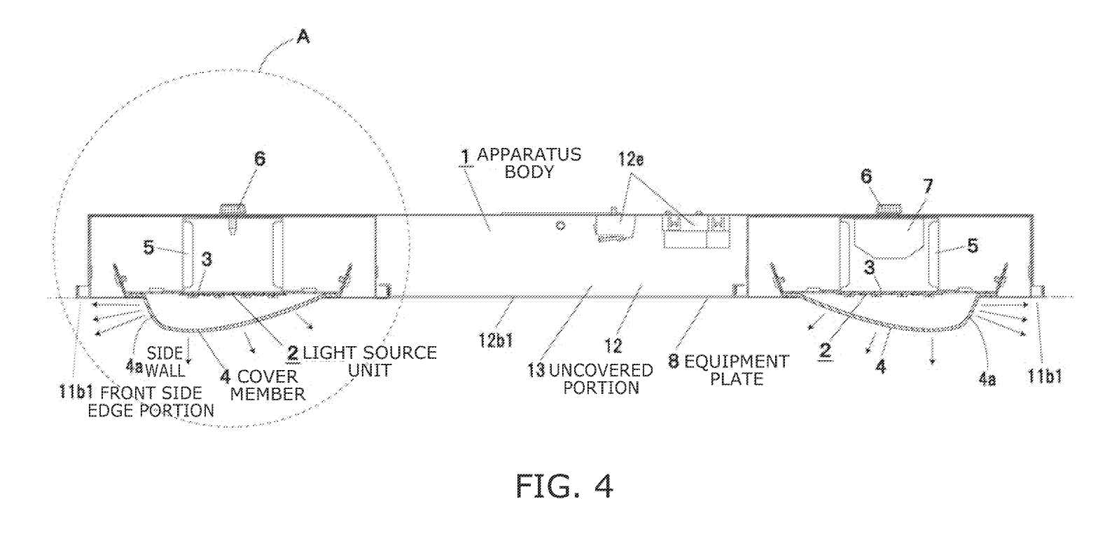

As illustrated in FIG. 3 and FIG. 4, the lighting device 7 is attached to the front side of the light source unit supporting member 11. The lighting device 7 is configured to perform the lighting control of the light source units 2, accommodate circuit board and circuit components mounted on the circuit board in a box-shaped case, is connected to a commercial alternating-current power supply AC, and generates a DC output upon reception of the commercial alternating-current power supply AC. The lighting device 7 is configured by connecting a smoothing capacitor between the output terminals of a full-wave rectifying circuit and connecting a DC voltage converting circuit and current detecting unit to the smoothing capacitor. Therefore, the lighting device 7 is connected to the light-emitting elements 22 via the substrates 21, and is configured to supply the DC output to the light-emitting elements 22 and perform the lighting control of the light-emitting elements 22.

In this manner, in a state in which the modules M are disposed in the apparatus body 1, the cover members 4 are arranged within an outline of the substantially square-shaped apparatus body 1 formed by the front side edge portions 11b1 of the light source unit supporting members 11 and the front side edge portions 12b1 of the end plate members 12 as shown in FIG. 2.

More specifically, the cover members 4 are arranged on both sides of the substantially square-shaped apparatus body 1 while leaving a substantially center portion. In other words, an uncovered portion 13 which is not covered by the cover members 4 is formed at the substantially center portion of the apparatus body 1.

As illustrated also in FIG. 4 and FIG. 5, the cover members 4 are arranged so as to project from the front side edge portions 11b1 and 12b1 of the apparatus body 1, and the side wall 4a of the cover members 4 formed upright are arranged so as to extend along the front side edge portions 11b1 and 12b1.

As illustrated in FIG. 2 as a representative, the equipment plate 8 is disposed on the uncovered portion 13. The equipment plate 8 has a substantially rectangular flat panel shape, and is formed by painting metallic plates such as hot dip galvanizing steel plates or the like white. Plates provided with the nominal designation of a target equipment such as Emergency Light, Speaker, Smoke Detector, Sprinkler, are applied as the equipment plate 8.

In the state in which the luminaire is installed, if power is supplied to the lighting device 7, a DC output is supplied to the light source units 2, and power is distributed to the light-emitting elements 22 via the substrates 21, and the respective light-emitting elements 22 are turned ON. Light emitted from the light-emitting elements 22 passes through the phosphor layers 23, passes through the milky-white translucent cover members 4 and hence is diffused and radiated mainly downward, so that a predetermined light distribution range is illuminated.

In contrast, since the side wall 4a of the cover members 4 is formed so as to extend upright at a predetermined inner angle θ, the light passing through the side wall 4a is diffused as illustrated in FIG. 4, and part of the light acts to illuminate the ceiling side (illustrated by arrows in FIG. 4). Accordingly, light emitted from the light source units 2 is radiated downward and toward the ceiling, so that the light distribution range is widened, and a feeling of brightness is improved.

In addition, since the uncovered portion 13 which is not covered with the cover member 4 is formed at the substantially center portion of the apparatus body 1, the area of the uncovered portion 13 may become a dark portion, so that the feeling of brightness may be lowered. However, the light distribution range may be widened as described above, and hence lowering of the feeling of brightness may be compensated. Therefore, as in the embodiment, in the luminaire in which the uncovered portion 13 is formed, forming the side wall 4a of the cover members 4 so as to extend upright is an effective measure.

Heat is generated when the respective light-emitting elements 22 are turned on. The heat generated by the respective light-emitting elements 22 is transmitted mainly from the back side of the substrates 21 to the thermal radiation members 3, is transmitted from the thermal radiation members 3 to the supporting fixtures 5, and is transmitted to the entire part of the apparatus body 1 and then is radiated. Accordingly, the temperature rise of the light-emitting elements 22 is inhibited.

As described above, according to the embodiment, there is provided the luminaire which achieves improvement of the feeling of brightness by widening the light distribution range of light emitted from the light source units 2.

The cover member may be disposed so as to surround the entire circumference of the uncovered portion. In this case as well, the cover member may be projected from the front side edge portion of the apparatus body, and the side walls of the cover member formed along the edge portions thereof so as to extend upright may be arranged. Furthermore, the upright side walls may partly be formed. In this configuration as well, the same effects and advantages as the embodiment described above may be achieved.

The invention is not limited to the configuration of the above-described embodiment, and various modifications may be made without departing the scope of the invention. The embodiments described above are shown as an example and are not intended to limit the scope of the invention. For example, solid light-emitting elements such as LED and organic ELs are applicable as the light-emitting element.

Although several embodiments of the invention have been described, these embodiments or the examples are presented as examples and are not intended to limit the scope of the invention. These novel embodiments or the examples may be implemented in other various modes, and various omissions, replacements, and modifications may be made without departing the scope of the invention. The embodiments or examples and the modifications are included in the scope and gist of the invention, and are included within the range of the invention described in Claims and a range equivalent thereof.

What is claimed is:

1. A luminaire comprising:
an apparatus body;
a light source unit disposed in the apparatus body and including a light-emitting element as a light source;
a cover member having translucency and diffusing properties, being formed so as to project from a front side edge portion of the apparatus body, including a side wall extending along the edge portion and formed upright within a range of inner angle from 60° to 90° with reference to a horizontal plane at least partly along the edge portion, and covering the light source unit so as to leave a substantially center portion of the apparatus body as an uncovered portion.

2. The luminaire according to claim 1, wherein an equipment plate provided with a nominal designation of equipment is disposed on the uncovered portion.

3. The luminaire according to claim 2, wherein the nominal designation of equipment is at least one of Emergency Light, Speaker, Smoke Detector, and Sprinkler.

4. The luminaire according to claim 1, wherein the cover member is formed to have a top portion deviated to one side in side view.

5. The luminaire according to claim 1, wherein the cover member faces the light source unit and has an outer inclination lager than an inner inclination.

6. The luminaire according to claim 1, wherein the cover member includes a flat mounting strip coming into contact with an inner side of the apparatus body.

7. The luminaire according to claim 6, wherein the cover member is provided so as to project outward from the apparatus body.

8. The luminaire according to claim 1, wherein the cover member is formed into a curved shape so as to face the light source unit.

9. The luminaire according to claim 1, further comprising a thermal radiator provided so as to be in surface contact with the light source unit.

10. The luminaire according to claim 9, wherein the surface of the thermal radiator is painted in white.

11. The luminaire according to claim 9, wherein the cover member is held between the apparatus body and the thermal radiator.

12. The luminaire according to claim 1, wherein the light source unit includes a resist layer configured to reflect light radiated from the light-emitting element.

13. The luminaire according to claim 9, wherein a back side of the light source unit is covered with the thermal radiator, and a front side of the light source unit is covered with the cover member, and the light source unit and the thermal radiator and the cover member constitute a module.

14. A luminaire comprising:
a light source unit having a light-emitting element; and
a cover member formed into a curved shape so as to face the light-emitting element and includes a top portion deviated to one side in side view.

15. The luminaire according to claim 14, wherein the cover member includes a diffusing agent that diffuses light.

16. The luminaire according to claim 14, wherein the cover member covers the light source unit.

17. The luminaire according to claim 14, wherein the cover member includes a side wall formed so as to extend upright within a range of an inner angle from 60° to 90° with reference to a mounting surface of the light-emitting element.

18. The luminaire according to claim 14, wherein at least part of the cover member is formed so as to extend upright within a range of an inner angle from 60° to 90° from the mounting surface of the light-emitting element.

19. The luminaire according to claim 14, further comprising an apparatus body having an uncovered portion having the light source unit mounted thereon and being not covered by the cover member.

20. The luminaire according to claim 19 wherein the uncovered portion is provided with a nominal designation of equipment.
